(19) United States
(12) Patent Application Publication
(10) Pub. No.: US 2025/0274042 A1
(43) Pub. Date: Aug. 28, 2025

(54) SEMICONDUCTOR DEVICE

(71) Applicant: TAIWAN SEMICONDUCTOR MANUFACTURING COMPANY, LTD., Hsinchu (TW)

(72) Inventors: Che-Ming HUNG, Hsinchu County (TW); Shih-Hsin TENG, Taichung City (TW)

(73) Assignee: TAIWAN SEMICONDUCTOR MANUFACTURING COMPANY, LTD., Hsinchu (TW)

(21) Appl. No.: 18/584,092

(22) Filed: Feb. 22, 2024

(51) Int. Cl. H02M 3/07

(52) U.S. Cl. CPC H02M 3/07

(57) ABSTRACT

A device includes a charge pump and a first switch. The charge pump is configured to output an output voltage signal according to a first node. The charge pump includes a first diode and a clock buffer. The first diode is configured to receive a first voltage signal and is coupled to the first node. The clock buffer is configured to adjust the first node according to a second node. The first switch is configured to adjust the second node according to the first voltage signal.

### BACKGROUND

Some semiconductor devices include charge pumps to increase or decrease the power input voltage level. Some charge pumps are formed by regulated low dropout (LDO) circuits. However, LDO circuits cause extra voltage drop and longer response time, and affect the driving capability of the charge pumps.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1 is a schematic diagram of a semiconductor device, in accordance with some embodiments of the present disclosure.

FIG. 2 is a schematic diagram of a semiconductor device, in accordance with some embodiments of the present disclosure.

FIG. 3 is a schematic diagram of an adaptive controller in the semiconductor device shown in FIG. 1, in accordance with some embodiments of the present disclosure.

FIG. 4 is a schematic diagram of a semiconductor device, in accordance with some embodiments of the present disclosure.

FIG. 5 is a flowchart diagram of a method operating at least one of the semiconductor devices shown in FIG. 1, FIG. 2 and FIG. 4, in accordance with some embodiments of the present disclosure.

FIG. 6 is a schematic view of a system for designing and manufacturing of at least one of the semiconductor devices shown in FIG. 1, FIG. 2 and FIG. 4, in accordance with some embodiments of the present disclosure.

FIG. 7 is a block diagram of an integrated circuit (IC)/semiconductor device manufacturing system, and an IC manufacturing flow associated therewith, in accordance with some embodiments of the present disclosure.

### DETAILED DESCRIPTION

The following disclosure provides many different embodiments, or examples, for implementing different features of the provided subject matter. Specific examples of components, materials, values, steps, arrangements or the like are described below to simplify the present disclosure. These are, of course, merely examples and are not intended to be limiting. Other components, materials, values, steps, arrangements or the like are contemplated. For example, the formation of a first feature over or on a second feature in the description that follows may include embodiments in which the first and second features are formed in direct contact, and may also include embodiments in which additional features may be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed.

Further, spatially relative terms, such as “beneath,” “below,” “lower,” “above,” “upper” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The device may be otherwise oriented (rotated 90 degrees or at other orientations) and the spatially relative descriptors used herein may likewise be interpreted accordingly. As used herein, “around,” “about,” “approximately,” or “substantially” may generally mean within 20 percent, or within 10 percent, or within 5 percent of a given value or range. Numerical quantities given herein are approximate, meaning that the term “around,” “about,” “approximately,” or “substantially” can be inferred if not expressly stated. One skilled in the art will realize, however, that the values or ranges recited throughout the description are merely examples, and may be reduced or varied with the down-scaling of the integrated circuits.

The terms applied throughout the following descriptions and claims generally have their ordinary meanings clearly established in the art or in the specific context where each term is used. Those of ordinary skill in the art will appreciate that a component or process may be referred to by different names. Numerous different embodiments detailed in this specification are illustrative only, and in no way limits the scope and spirit of the disclosure or of any exemplified term.

It is worth noting that the terms such as “first” and “second” used herein to describe various elements or processes aim to distinguish one element or process from another. However, the elements, processes and the sequences thereof should not be limited by these terms. For example, a first element could be termed as a second element, and a second element could be similarly termed as a first element without departing from the scope of the present disclosure.

In the following discussion and in the claims, the terms “comprising,” “including,” “containing,” “having,” “involving,” and the like are to be understood to be open-ended, that is, to be construed as including but not limited to. As used herein, instead of being mutually exclusive, the term “and/or” includes any of the associated listed items and all combinations of one or more of the associated listed items.

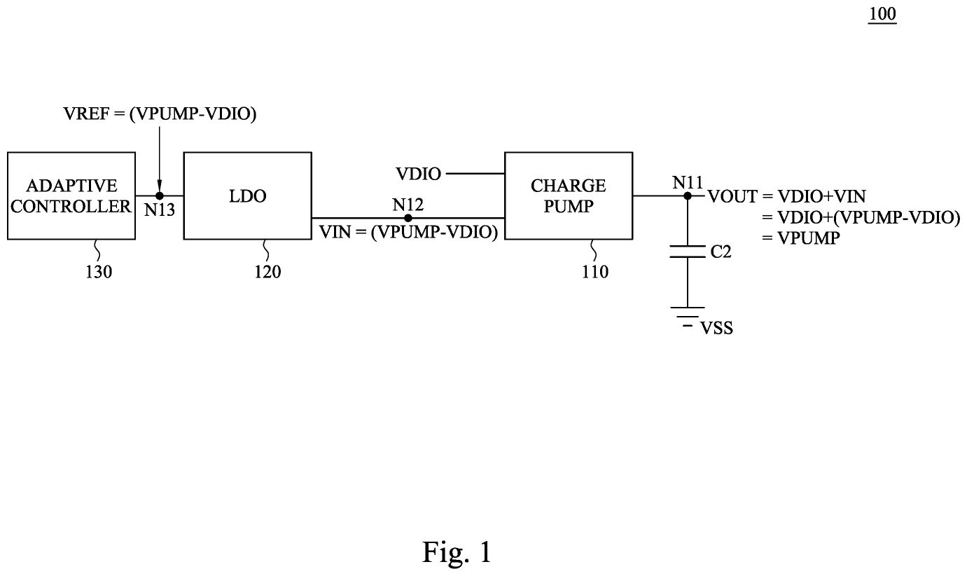

FIG. 1 is a schematic diagram of a semiconductor device 100, in accordance with some embodiments of the present disclosure. As illustratively shown in FIG. 1, the semiconductor device 100 includes a charge pump 110, a low dropout (LDO) regulator 120, an adaptive controller 130, and a capacitor C2. In some embodiments, the charge pump 110 is configured to generate an output voltage signal VOUT according to a system voltage signal VDIO and an input voltage signal VIN. The LDO regulator 120 is configured to generate the input voltage signal VIN according to a reference voltage signal VREF. The adaptive controller 130 is configured to generate the reference voltage signal VREF. The capacitor C2 is configured to stabilize the output voltage signal VOUT through capacitive coupling.

As illustratively shown in FIG. 1, a first terminal of the capacitor C2 is connected to a reference voltage signal VSS, and a second terminal of the capacitor C2 is coupled to a node N11. A first terminal of the charge pump 110 is configured to output the output voltage signal VOUT to the node N11, a second terminal of the charge pump 110 is configured to receive the system voltage signal VDIO, and a third terminal of the charge pump 110 is configured to receive the input voltage signal VIN from a node N12. A first terminal of the LDO regulator 120 is configured to output the input voltage signal VIN to the node N12, and a second terminal of the LDO regulator 120 is configured to receive the reference voltage signal VREF from a node N13. A first terminal of the adaptive controller 130 is configured to output the reference voltage signal VREF to the node N13. In some embodiments, the node N11 is connected to a memory device, such as an effuse memory, an one-time programming (OTP) memory, a resistive random access memory (RRAM), a magnetoresistive random-access memory (MRAM), a flash memory or the like.

In some embodiments, the reference voltage signal VSS has a ground voltage level, such as 0V. The reference voltage signal VREF has a voltage level V1. The input voltage signal VIN has a voltage level V2. The system voltage signal VDIO has a voltage level V3. The output voltage signal VOUT has a voltage level V4. The voltage level V4 is approximately equal to a sum of the voltage level V3 and the voltage level V2. The voltage level V2 is approximately equal to the voltage level V1. The charge pump 110 is configured to sum a voltage level of the system voltage signal VDIO and a voltage level of the input voltage signal VIN to generate the output voltage signal VOUT. The LDO regulator 120 is configured to adjust the reference voltage signal VREF to generate the input voltage signal VIN.

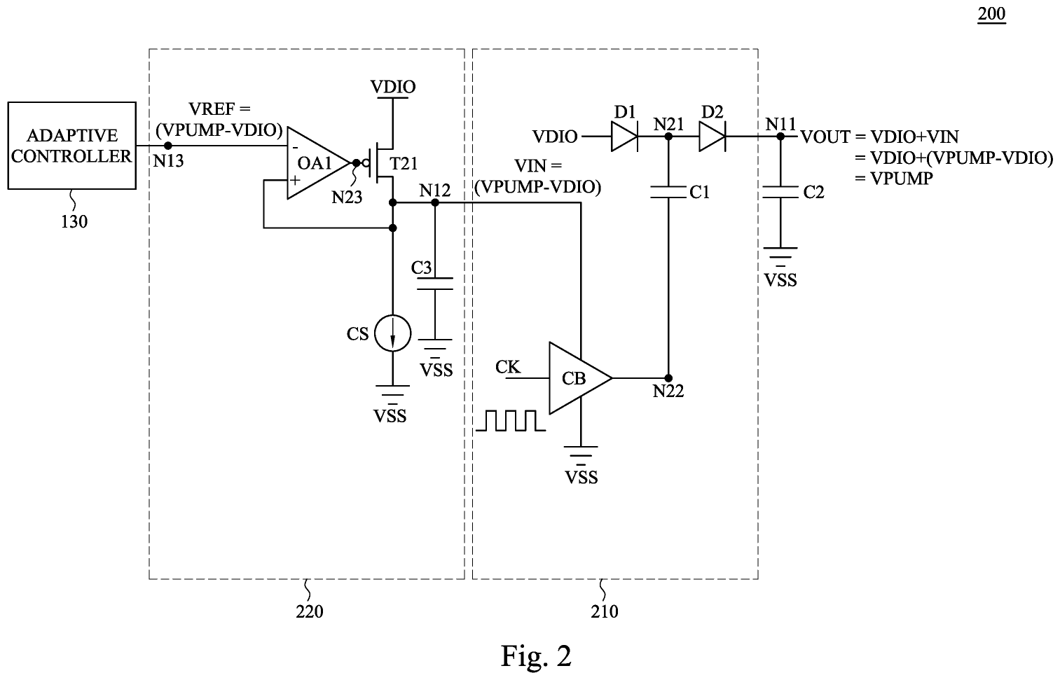

FIG. 2 is a schematic diagram of a semiconductor device 200, in accordance with some embodiments of the present disclosure. Referring to FIG. 2 and FIG. 1, the semiconductor device 200 is an embodiment of the semiconductor device 100. FIG. 2 follows a similar labeling convention to that of FIG. 1.

As illustratively shown in FIG. 2, the semiconductor device 200 includes a charge pump 210, a LDO regulator 220, the adaptive controller 130, and the capacitor C2. Referring to FIG. 2 and FIG. 1, the charge pump 210 is an embodiment of the charge pump 110. The LDO regulator 220 is an embodiment of the LDO regulator 120.

As illustratively shown in FIG. 2, the charge pump 210 includes a capacitor C1, diodes D1 and D2, and a clock buffer CB. A first terminal of the capacitor C1 is coupled to an output terminal of the clock buffer CB at a node N22, and a second terminal of the capacitor C1 is coupled to a node N21. A first terminal of the diode D1 is configured to receive the system voltage signal VDIO, and a second terminal of the diode D1 is coupled to a first terminal of the diode D2 at the node N21. A second terminal of the diode D2 is coupled to the node N11. An input terminal of the clock buffer CB is configured to receive a clock signal CK, a first terminal of the clock buffer CB is configured to receive the reference voltage signal VSS, and a second terminal of the clock buffer CB is configured to receive the input voltage signal VIN from the node N12. In some embodiments, the first terminal of the clock buffer CB and the second terminal of the clock buffer CB are referred to as power terminals of the clock buffer CB.

As illustratively shown in FIG. 2, the LDO regulator 220 includes a capacitor C3, a current source CS, a switch T21, and an operational amplifier OA1. A first terminal of the capacitor C3 is configured to receive the reference voltage signal VSS, and a second terminal of the capacitor C3 is coupled to the node N12. A first terminal of the current source CS is configured to receive the reference voltage signal VSS, and a second terminal of the current source CS is coupled to the node N12. A first terminal of the switch T21 is coupled to the node N12, and a second terminal of the switch T21 is configured to receive the system voltage signal VDIO. A control terminal of the switch T21 is coupled to an output terminal of the operational amplifier OA1 at a node N23. A positive terminal of the operational amplifier OA1 is coupled to the node N21, and a negative terminal of the operational amplifier OA1 is configured to receive the reference voltage signal VREF at the node N13. In some embodiments, the switch T21 is implemented by a P-type metal-oxide-semiconductor (PMOS) transistor.

In some embodiments, in the charge pump 210, the diode D1 and the capacitor C1 is configured to adjust a voltage level of the node N21. The clock buffer CB is configured to adjust voltage levels of the node N22, N21 and N11. Specifically, in response to the clock signal CK having a high voltage level, the clock buffer CB outputs the input voltage signal VIN to the node N22 to adjust the node N22 to the voltage level V2, and the capacitor C1 adjusts the node N21 from the voltage level V3 to the voltage level V4 through capacitive coupling. Accordingly, the voltage level of the node N11 is adjusted to the voltage level V4 through the diode D2. In some embodiments, the clock signal switches between the high voltage level, such as 1V, and a low voltage level, such as 0V, in a periodical manner.

In some embodiments, in the LDO regulator 220, the capacitor C3 is configured to stabilize the voltage level of the node N12 through capacitive coupling. The current source CS is configured to supply a current to bias or activate the switch T21, such as a current of 2 mA or 5 mA. The switch T21 and the operational amplifier OA1 are configured to adjust the voltage level of the node N12 to the voltage level V2. Specifically, when the voltage level of the node N12 is lower than the voltage level V2, which means that the voltage level of the positive terminal of the operational amplifier OA1 is lower than the voltage level of the negative terminal of the operational amplifier OA1, the operational amplifier OA1 outputs the low voltage level to the node N23. Accordingly, the switch T21 is turned on and supplies the system voltage signal VDIO to the node N12. Similarly, when the voltage level of the node N12 is higher than the voltage level V2, which means that the voltage level of the positive terminal of the operational amplifier OA1 is higher than the voltage level of the negative terminal of the operational amplifier OA1, the operational amplifier OA1 outputs the high voltage level to the node N23. Accordingly, the switch T21 is turned off.

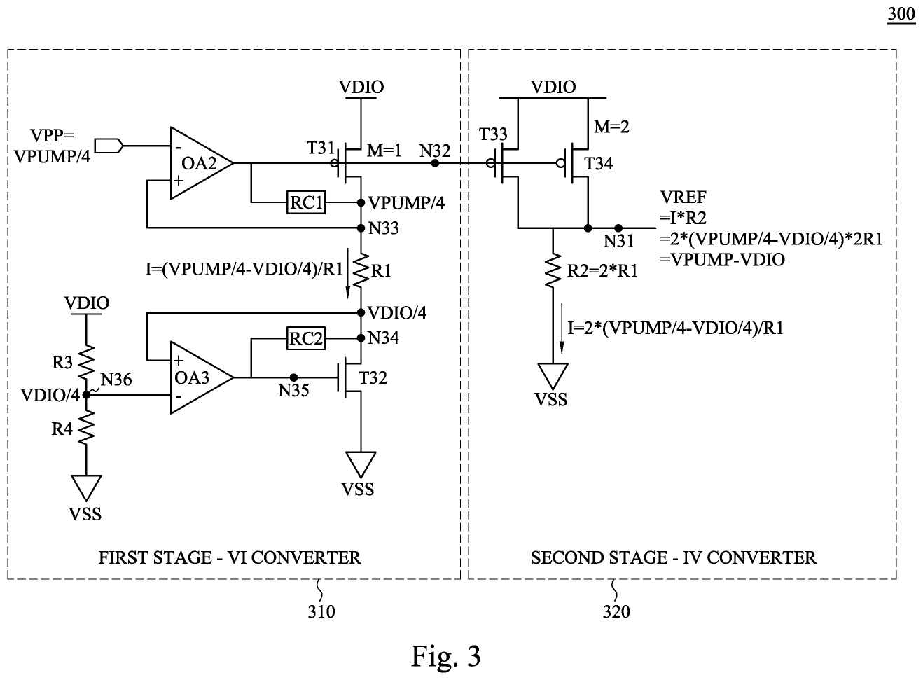

FIG. 3 is a schematic diagram of an adaptive controller 300 in the semiconductor device 100 shown in FIG. 1, in accordance with some embodiments of the present disclosure. Referring to FIG. 3 and FIG. 1, the adaptive controller 300 is an embodiment of the adaptive controller 130. As illustratively shown in FIG. 3, the adaptive controller 300 includes a voltage-to-current (V-I) converter 310 and a current-to-voltage (I-V) converter 320. The V-I converter 310 is coupled to the I-V converter 320 at a node N32. In some embodiments, the V-I converter 310 is referred to as a first stage of the adaptive controller 300, and the I-V converter 320 is referred to as a second stage of the adaptive controller 300.

As illustratively shown in FIG. 3, the V-I converter 310 includes switches T31 and T32, resistors R1, R3 and R4, resistor-capacitor (RC) circuits RC1 and RC2, and operational amplifiers OA2 and OA3. A first terminal of the switch T31 is coupled to a node N33, a second terminal of the switch T31 is configured to receive the system voltage signal VDIO, and a control terminal of the switch T31 is coupled to the node N32. A first terminal of the switch T32 is configured to receive the reference voltage signal VSS, a second terminal of the switch T32 is coupled to a node N34, and a control terminal of the switch T32 is coupled to a node N35. A first terminal of the resistor R1 is coupled to the node N34, and a second terminal of the resistor R1 is coupled to the node N33. A first terminal of the resistor R3 is coupled to a node N36, and a second terminal of the resistor R3 is configured to receive the system voltage signal VDIO. A first terminal of the resistor R4 is configured to receive the reference voltage signal VSS, and a second terminal of the resistor R4 is coupled to the node N36. A terminal of the RC circuit RC1 is coupled to the node N32, and another terminal of the RC circuit RC1 is coupled to the node N33. A terminal of the RC circuit RC2 is coupled to the node N35, and another terminal of the RC circuit RC2 is coupled to the node N34. An output terminal of the operational amplifier OA2 is coupled to the node N32, a positive terminal of the operational amplifier OA2 is coupled to the node N33, and a negative terminal of the operational amplifier OA2 is configured to receive a pump voltage signal VPP. An output terminal of the operational amplifier OA3 is coupled to the node N35, a positive terminal of the operational amplifier OA3 is coupled to the node N34, and a negative terminal of the operational amplifier OA3 is coupled to the node N36.

As illustratively shown in FIG. 3, the I-V converter 320 includes switches T33 and T34, and a resistor R2. First terminals of the switches T33 and T34 are coupled to a node N31, second terminals of the switches T33 and T34 are configured to receive the system voltage signal VDIO, and control terminals of the switches T33 and T34 are coupled to the node N32. A first terminal of the resistor R2 is configured to receive the reference voltage signal VSS, and a second terminal of the resistor R2 is coupled to the node N31. Referring to FIG. 3 and FIG. 1, the node N31 is coupled to the node N13.

In some embodiments, the RC circuits RC1 and RC2 include resistors and capacitors connected in series or in parallel, and are configured for frequency compensation. In some embodiments, each of the switches T31, T33 and T34 is implemented by a PMOS transistor, and the switch T32 is implemented by an N-type metal-oxide-semiconductor (NMOS) transistor. The resistor R1 has a resistance Z1. The resistor R2 has a resistance Z2. The resistor R3 has a resistance Z3. The resistor R4 has a resistance Z4. In some embodiments, each of the resistors R3 and R4 is implemented by one or more transistors coupled in series, and various resistances of the resistors R3 and R4 are achieved by coupling various numbers of transistors in series.

In some embodiments, the pump voltage signal VPP has a voltage level V5. The voltage level V5 is approximately equal to one-Nth of the voltage level V4, for N being a positive integer. The pump voltage signal VPP is generated by a bandgap circuit. The bandgap circuit is configured to generate various voltage levels through resistance voltage separation, such as voltages of 0.1V, 0.2V or the like. The node N36 has a voltage signal VD1 with a voltage level V6. In some embodiments, the voltage level V6 is approximately equal to one-Nth of the voltage level V3. The voltage level V6 is generated through voltage separation by resistors R3 and R4. Specifically, the voltage level V6 is determined by a ratio of the resistance Z3 and the resistance value Z4. For example, when the resistance Z3 is approximately equal to the resistance Z4, the voltage level V6 is set to a voltage level of the voltage level V3 divided by 2. For another example, when the resistance Z3 is approximately three times the resistance Z4, the voltage level V6 is set to a voltage level of the voltage level V3 divided by 4.

In some embodiments, in the V-I converter 310, the switch T31 and the operational amplifier OA2 are configured to adjust a voltage level of the node N33 to the voltage level V5. Specifically, when the voltage level of the node N33 is lower than the voltage level V5, which means that the voltage level of the positive terminal of the operational amplifier OA2 is lower than the voltage level of the negative terminal of the operational amplifier OA2, the operational amplifier OA2 outputs the low voltage level to the node N32. Accordingly, the switch T31 is turned on and supplies the system voltage signal VDIO to the node N33. Similarly, when the voltage level of the node N33 is higher than the voltage level V5, which means that the voltage level of the positive terminal of the operational amplifier OA2 is higher than the voltage level of the negative terminal of the operational amplifier OA2, the operational amplifier OA2 outputs the high voltage level to the node N32. Accordingly, the switch T31 is turned off.

In some embodiments, in the V-I converter 310, the switch T32 and the operational amplifier OA3 are configured to adjust a voltage level of the node N34 to the voltage level V6. Specifically, when the voltage level of the node N34 is lower than the voltage level V6, which means that the voltage level of the positive terminal of the operational amplifier OA3 is lower than the voltage level of the negative terminal of the operational amplifier OA3, the operational amplifier OA3 outputs the low voltage level to the node N35. Accordingly, the switch T32 is turned off, and the node N33 supplies the voltage level V5 to the node N34. Similarly, when the voltage level of the node N34 is higher than the voltage level V6, which means that the voltage level of the positive terminal of the operational amplifier OA3 is higher than the voltage level of the negative terminal of the operational amplifier OA3, the operational amplifier OA3 outputs the high voltage level to the node N35. Accordingly, the switch T32 is turned on and supplies the reference voltage signal VSS to the node N34.

In some embodiments, the V-I converter 310 is configured to generate a current with a current value I1 flowed from the node N33 to the node N34. The current value I1 is calculated as the voltage level V5 subtracted by the voltage level V6 and divided by the resistance Z1 [(V5−V6)/Z1].

In some embodiments, the I-V converter 320 is configured to generate a current with a current value I2 flowed through the resistor R2. The current value I2 is multiplied by the current value I1 and a number of the switches in the I-V converter 320. Specifically, when the number of the switches in the I-V converter 320 is M, for M being a positive integer, the current value I2 is approximately M times the current value I1. For example, when the number of the switches in the I-V converter 320 is 2 and the current value I1 is the voltage level V5 subtracted by the voltage level V6 and divided by the resistance Z1 [(V5−V6)/Z1], the current value I2 is approximately equal to the voltage level V5 subtracted by the voltage level V6 and times 2 divided by the resistance Z1 [2*(V5−V6)/Z1].

In some embodiments, in the I-V converter 320, the voltage level V1 is calculated by the current value I2 and the resistance Z2. For example, when the current value I2 is the voltage level V5 subtracted by the voltage level V6 and times 2 divided by the resistance Z1 [2*(V5−V6)/Z1] and the resistance Z2 is approximately twice the resistance Z1, the voltage level V1 is approximately equal to the voltage level V5 subtracted by the voltage level V6 and times 4 divided by the resistance Z1 [4*(V5−V6)/Z1].

In some embodiments, the pump voltage signal VPP, the system voltage signal VDIO, the resistors R1-R4, and the number of the switches in the I-V converter 320 are configured to generate the reference voltage signal VREF. Specifically, when the voltage level V5 is approximately equal to the voltage level V4 divided by N through voltage separation and the voltage level V6 is approximately equal to the voltage level V3 divided by N through voltage separation of the resistors R3 and R4, the number of the switches in the I-V converter 320 is M, and the ratio of the resistors R2 and R1 is X, for X being a positive integer, the voltage level V1 is approximately equal to the voltage level V4 subtracted by the voltage level V3 multiplied by M and X divided by N [(V4−V3)*M*X/N]. In summary, in order to set the voltage level V1 as the voltage level V4 subtracted by the voltage level V3, a condition of that M multiplied by X divided by N equals 1 (M*X/N=1) is required. Accordingly, each of the voltage levels V5 and V6, the number of the switches in the I-V converter 320, and the ratio of the resistors R2 and R1 are set to meet an equation of M multiplied by X divided by N equals 1 (M*X/N=1). In some embodiments, each of N and X is a positive number other than integers.

In some approaches, in a charge pump, an LDO circuit is required to address issues of high output voltage ripple. However, the LDO circuit causes extra voltage drop and longer response time. As a result, the driving capability and efficiency of the charge pump is low.

Compared to above approaches, in some embodiments of present disclosure, the first terminal of the diode D1 is connected directly to the system voltage signal VDIO, such that the resistance between the system and the charge pump the charge pump 110 is low. The voltage and current are supplied by the adaptive controller 130, the LDO regulator 120 and the diode D1, such that the loads of the elements are reduced. As a result, the driving capability and efficiency are improved. Furthermore, the output voltage signal VOUT is adjustable, which is adaptive to various semiconductor devices.

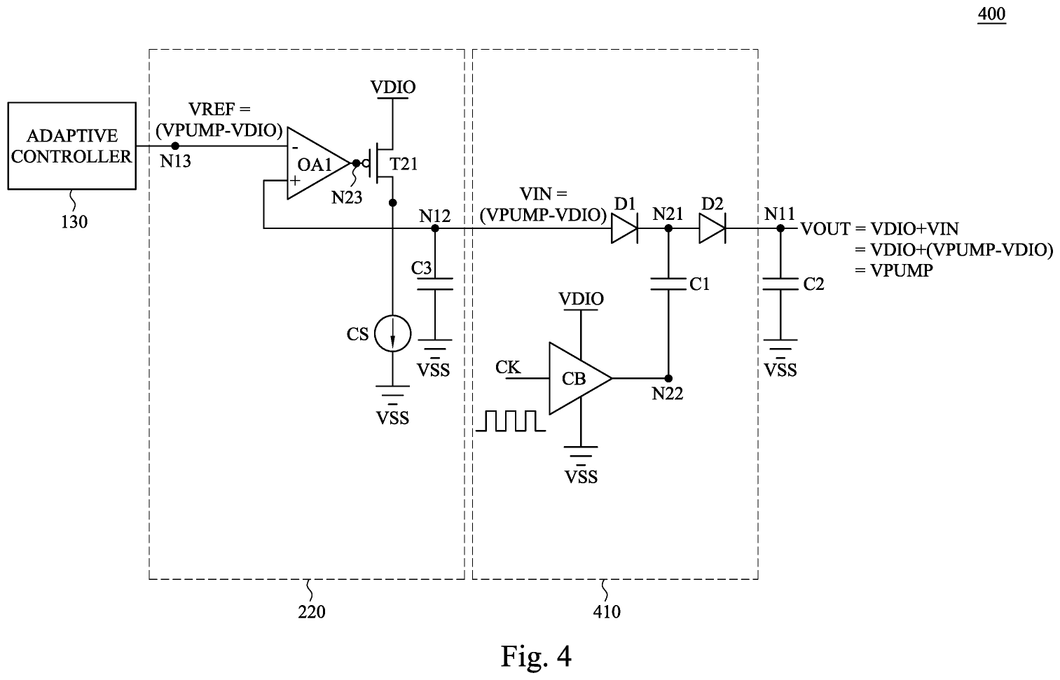

FIG. 4 is a schematic diagram of a semiconductor device 400, in accordance with some embodiments of the present disclosure. Referring to FIG. 4 and FIG. 2, the semiconductor device 400 is an alternative embodiment of the semiconductor device 200. FIG. 4 follows a similar labeling convention to that of FIG. 2. For brevity, the discussion will focus more on differences between FIG. 4 and FIG. 2 than on similarities.

As illustratively shown in FIG. 4, the semiconductor device 400 includes a charge pump 410 instead of the charge pump 210. The first terminal of the diode D1 is configured to receive the input voltage signal VIN from the node N12 instead of receiving the system voltage signal VDIO. The second terminal of the clock buffer CB is configured to receive the system voltage signal VDIO instead of receiving the input voltage signal VIN from the node N12.

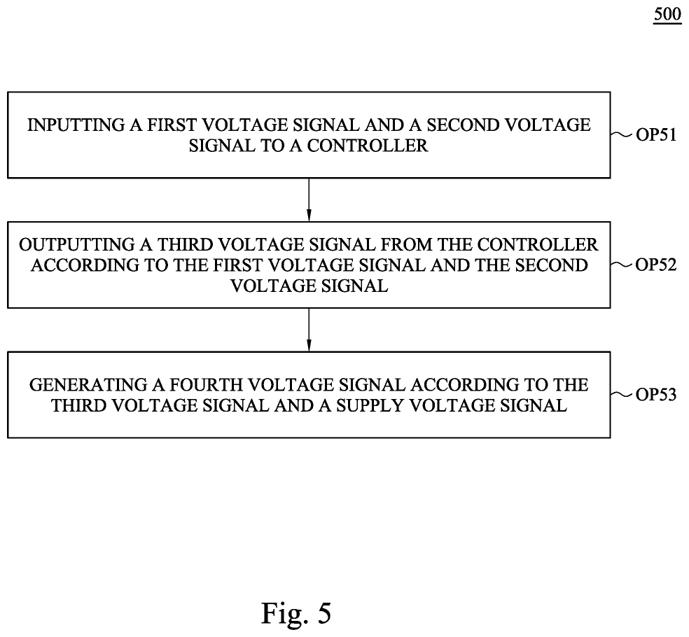

FIG. 5 is a flowchart diagram of a method 500 operating at least one of the semiconductor devices 100, 200 and 400 shown in FIG. 1, FIG. 2 and FIG. 4, in accordance with some embodiments of the present disclosure. As illustratively shown in FIG. 5, the method 500 includes operations OP51-OP53.

During the operation OP51, a first voltage signal and a second voltage signal are inputted to a controller. For example, the pump voltage signal VPP and the voltage signal VD1 are inputted to the adaptive controller 300 shown in FIG. 3.

During the operation OP52, a third voltage signal is outputted from the controller according to the first voltage signal and the second voltage signal. For example, the input voltage signal VIN is outputted from the adaptive controller 130 according to the pump voltage signal VPP and the voltage signal VD1 shown in FIG. 2 and FIG. 3. For another example, the input voltage signal VIN is outputted from the adaptive controller 130 according to the pump voltage signal VPP and the voltage signal VD1 shown in FIG. 4 and FIG. 3.

During the operation OP53, a fourth voltage signal is generated according to the third voltage signal and a supply voltage signal. For example, the output voltage signal VOUT is generated according to the input voltage signal VIN and the system voltage signal VDIO shown in FIG. 2. For another example, the output voltage signal VOUT is generated according to the input voltage signal VIN and the system voltage signal VDIO shown in FIG. 4.

In some embodiments, the voltage level V5 of the pump voltage signal VPP is approximately equal to one-Nth of the voltage level V4 of the output voltage signal VOUT, for N being a positive integer. The voltage level V6 of the voltage signal VD1 is approximately equal to one-Nth of the voltage level V3 the supply voltage signal.

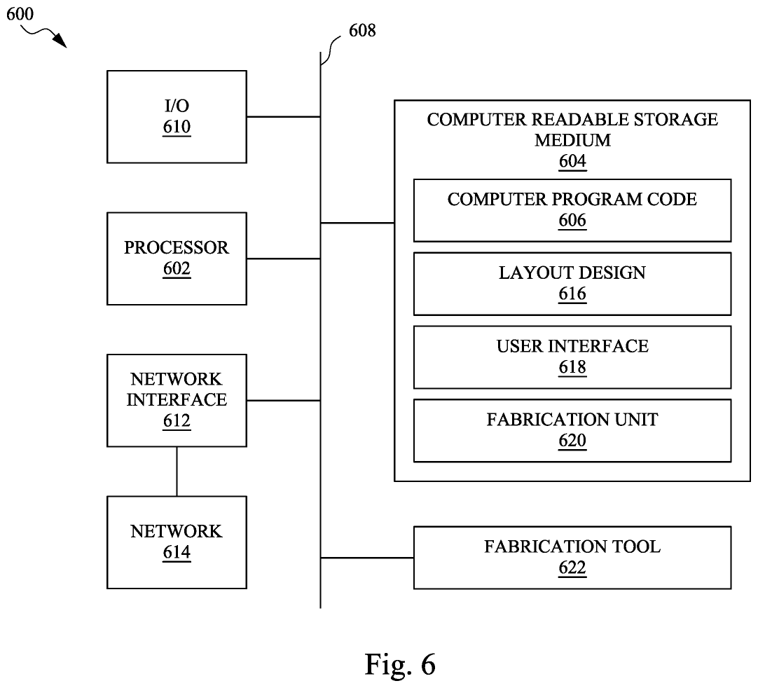

FIG. 6 is a schematic view of a system 600 for designing and manufacturing of at least one of the semiconductor devices 100, 200 and 400 shown in FIG. 1, FIG. 2 and FIG. 6, in accordance with some embodiments of the present disclosure. The system 600 generates or places one or more IC layout designs, as described herein. In some embodiments, the system 600 manufactures one or more semiconductor devices based on the one or more IC layout designs, as described herein. The system 600 includes a hardware processor 602 and a non-transitory, computer readable storage medium 604 encoded with, e.g., storing, the computer program code 606, e.g., a set of executable instructions. The computer readable storage medium 604 is configured for interfacing with manufacturing machines for producing the semiconductor device. The processor 602 is electrically coupled to the computer readable storage medium 604 by a bus 608. The processor 602 is also electrically coupled to an I/O interface 610 by the bus 608. A network interface 612 is also electrically connected to the processor 602 by the bus 608. Network interface 612 is connected to a network 614, so that the processor 602 and the computer readable storage medium 604 are capable of connecting to external elements via network 614. The processor 602 is configured to execute the computer program code 606 encoded in the computer readable storage medium 604 in order to cause the system 600 designing and manufacturing at least one of the semiconductor devices 100, 200 and 400.

In some embodiments, the processor 602 is a central processing unit (CPU), a multi-processor, a distributed processing system, an application specific integrated circuit (ASIC), and/or a suitable processing unit.

In some embodiments, the computer readable storage medium 604 is an electronic, magnetic, optical, electromagnetic, infrared, and/or a semiconductor system (or apparatus or device). For example, the computer readable storage medium 604 includes a semiconductor or solid-state memory, a magnetic tape, a removable computer diskette, a random access memory (RAM), a read-only memory (ROM), a rigid magnetic disk, and/or an optical disk. In some embodiments using optical disks, the computer readable storage medium 604 includes a compact disk-read only memory (CD-ROM), a compact disk-read/write (CD-R/W), and/or a digital video disc (DVD).

In some embodiments, the storage medium 604 also stores information needed for designing and manufacturing at least one of the semiconductor devices 100, 200 and 400, such as layout design 616, user interface 618, fabrication unit 620, and/or a set of executable instructions to perform the operation of designing and manufacturing at least one of the semiconductor devices 100, 200 and 400.

In some embodiments, the storage medium 604 stores instructions (e.g., the computer program code 606) for interfacing with manufacturing machines. The instructions (e.g., the computer program code 606) enable the processor 602 to generate manufacturing instructions readable by the manufacturing machines to effectively implement the designing and manufacturing at least one of the semiconductor devices 100, 200 and 400 during a manufacturing process.

The system 600 includes the I/O interface 610. The I/O interface 610 is coupled to external circuitry. In some embodiments, the I/O interface 610 includes a keyboard, keypad, mouse, trackball, trackpad, and/or cursor direction keys for communicating information and commands to the processor 602.

The system 600 also includes the network interface 612 coupled to the processor 602. The network interface 612 allows the system 600 to communicate with the network 614, to which one or more other computer systems are connected. The network interface 612 includes wireless network interfaces such as BLUETOOTH, WIFI, WIMAX, GPRS, or WCDMA; or wired network interface such as ETHERNET, USB, or IEEE-13154. In some embodiments, the designing and manufacturing at least one of the semiconductor devices 100, 200 and 400 is implemented in two or more systems 600, and information such as layout design, user interface and fabrication unit are exchanged between different systems 600 by the network 614.

The system 600 is configured to receive information related to a layout design through the I/O interface 610 or network interface 612. The information is transferred to the processor 602 by the bus 608 to determine a layout design for producing an IC. The layout design is then stored in the computer readable medium 604 as the layout design 616. The system 600 is configured to receive information related to a user interface through the I/O interface 610 or network interface 612. The information is stored in the computer readable medium 604 as the user interface 618. The system 600 is configured to receive information related to a fabrication unit through the I/O interface 610 or network interface 612. The information is stored in the computer readable medium 604 as the fabrication unit 620. In some embodiments, the fabrication unit 620 includes fabrication information utilized by the system 600.

In some embodiments, the designing and manufacturing at least one of the semiconductor devices 100, 200 and 400 is implemented as a standalone software application for execution by a processor. In some embodiments, the designing and manufacturing at least one of the semiconductor devices 100, 200 and 400 is implemented as a software application that is a part of an additional software application. In some embodiments, the designing and manufacturing at least one of the semiconductor devices 100, 200 and 400 is implemented as a plug-in to a software application. In some embodiments, the designing and manufacturing at least one of the semiconductor devices 100, 200 and 400 is implemented as a software application that is a portion of an EDA tool. In some embodiments, the designing and manufacturing at least one of the semiconductor devices 100, 200 and 400 is implemented as a software application that is used by an EDA tool. In some embodiments, the EDA tool is used to generate a layout design of the integrated circuit device. In some embodiments, the layout design is stored on a non-transitory computer readable medium. In some embodiments, the layout design is generated using a tool such as VIRTUOSO® available from CADENCE DESIGN SYSTEMS, Inc., or another suitable layout generating tool. In some embodiments, the layout design is generated based on a netlist which is created based on the schematic design. In some embodiments, the designing and manufacturing at least one of the semiconductor devices 100, 200 and 400 is implemented by a manufacturing device to manufacture an integrated circuit using a set of masks manufactured based on one or more layout designs generated by the system 600. In some embodiments, the system 600 includes a manufacturing device (e.g., fabrication tool 622) to manufacture an integrated circuit using a set of masks manufactured based on one or more layout designs of the present disclosure.

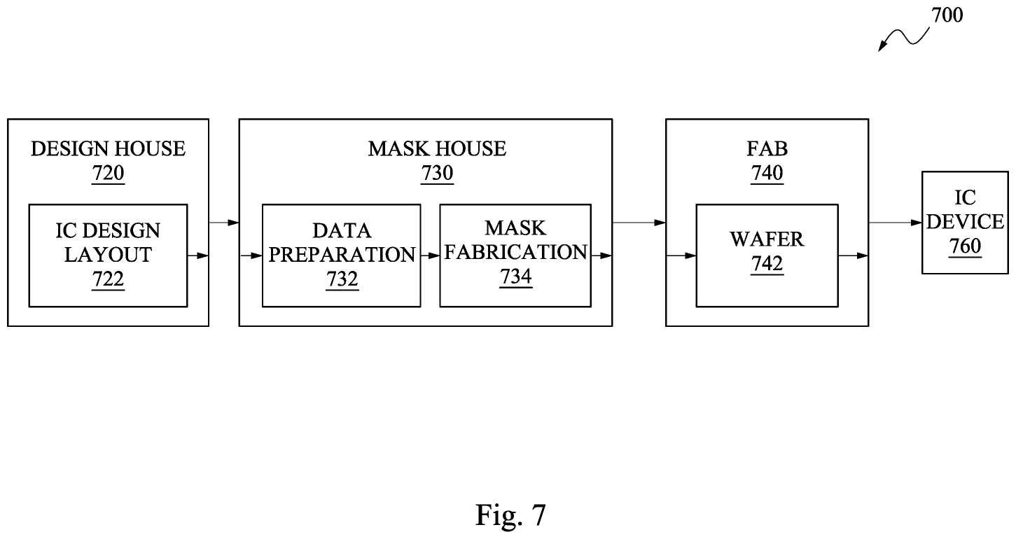

FIG. 7 is a block diagram of an integrated circuit (IC)/semiconductor device manufacturing system 700, and an IC manufacturing flow associated therewith, in accordance with some embodiments of the present disclosure.

In FIG. 7, the IC manufacturing system 700 includes entities, such as a design house 720, a mask house 730, and an IC manufacturer/fabricator (“fab”) 740, that interact with one another in the design, development, and manufacturing cycles and/or services related to manufacturing an IC device (semiconductor device) 760 including at least one of the semiconductor devices 100, 200 and 400. The entities in system 700 are connected by a communications network. In some embodiments, the communications network is a single network. In some embodiments, the communications network is a variety of different networks, such as an intranet and the Internet. The communications network includes wired and/or wireless communication channels. Each entity interacts with one or more of the other entities and provides services to and/or receives services from one or more of the other entities. In some embodiments, two or more of design house 720, mask house 730, and IC fab 740 is owned by a single company. In some embodiments, two or more of design house 720, mask house 730, and IC fab 740 coexist in a common facility and use common resources.

The design house (or design team) 720 generates an IC design layout 722. The IC design layout 722 includes various geometrical patterns designed for the IC device 760. The geometrical patterns correspond to patterns of metal, oxide, or semiconductor layers that make up the various components of the IC device 760 to be fabricated. The various layers combine to form various IC features. For example, a portion of the IC design layout 722 includes various IC features, such as an active region, gate structures, source/drain structures, interconnect structures, and openings for bonding pads, to be formed in a semiconductor substrate (such as a silicon wafer) and various material layers disposed on the semiconductor substrate. The design house 720 implements a proper design procedure to form the IC design layout 722. The design procedure includes one or more of logic design, physical design or place and route. The IC design layout 722 is presented in one or more data files having information of the geometrical patterns. For example, the IC design layout 722 can be expressed in a GDSII file format or DFII file format.

The mask house 730 includes mask data preparation 732 and mask fabrication 734. The mask house 730 uses the IC design layout 722 to manufacture one or more masks to be used for fabricating the various layers of the IC device 760 according to the IC design layout 722. The mask house 730 performs the mask data preparation 732, where the IC design layout 722 is translated into a representative data file (“RDF”). The mask data preparation 732 provides the RDF to the mask fabrication 734. The mask fabrication 734 includes a mask writer. A mask writer converts the RDF to an image on a substrate, such as a mask (reticle) or a semiconductor wafer, or a metal layer which is formed and thereafter selectively etched to form a redistribution layer at a back end of line process of the fab. The design layout is manipulated by the mask data preparation 732 to comply with particular characteristics of the mask writer and/or requirements of the IC fab 740. In FIG. 7, the mask data preparation 732 and mask fabrication 734 are illustrated as separate elements. In some embodiments, the mask data preparation 732 and mask fabrication 734 can be collectively referred to as mask data preparation.

In some embodiments, the mask data preparation 732 includes optical proximity correction (OPC) which uses lithography enhancement techniques to compensate for image errors, such as those that can arise from diffraction, interference, other process effects and the like. OPC adjusts the IC design layout 722. In some embodiments, the mask data preparation 732 includes further resolution enhancement techniques (RET), such as off-axis illumination, sub-resolution assist features, phase-shifting masks, other suitable techniques, and the like or combinations thereof. In some embodiments, inverse lithography technology (ILT) is also used, which treats OPC as an inverse imaging problem.

In some embodiments, the mask data preparation 732 includes a mask rule checker (MRC) that checks the IC design layout that has undergone processes in OPC with a set of mask creation rules which contain certain geometric and/or connectivity restrictions to ensure sufficient margins, to account for variability in semiconductor manufacturing processes, and the like. In some embodiments, the MRC modifies the IC design layout to compensate for limitations during the mask fabrication 734, which may undo part of the modifications performed by OPC in order to meet mask creation rules.

In some embodiments, the mask data preparation 732 includes lithography process checking (LPC) that simulates processing that will be implemented by the IC fab 740 to fabricate the IC device 760. LPC simulates this processing based on the IC design layout 722 to create a simulated manufactured device, such as the IC device 760. The processing parameters in LPC simulation can include parameters associated with various processes of the IC manufacturing cycle, parameters associated with tools used for manufacturing the IC, and/or other aspects of the manufacturing process. LPC takes into account various factors, such as aerial image contrast, depth of focus (“DOF”), mask error enhancement factor (“MEEF”), other suitable factors, and the like or combinations thereof. In some embodiments, after a simulated manufactured device has been created by LPC, if the simulated device is not close enough in shape to satisfy design rules, OPC and/or MRC can be repeated to further refine the IC design layout 722.

It should be understood that the above description of the mask data preparation 732 has been simplified for the purposes of clarity. In some embodiments, the mask data preparation 732 includes additional features such as a logic operation (LOP) to modify the IC design layout according to manufacturing rules. Additionally, the processes applied to the IC design layout 722 during the mask data preparation 732 may be executed in a variety of different orders.

After the mask data preparation 732 and during mask fabrication 734, a mask or a group of masks are fabricated based on the modified IC design layout. In some embodiments, an electron-beam (e-beam) or a mechanism of multiple e-beams is used to form a pattern on a mask (photomask or reticle) based on the modified IC design layout. The mask can be formed in various technologies. In some embodiments, the mask is formed using binary technology. In some embodiments, a mask pattern includes opaque regions and transparent regions. A radiation beam, such as an ultraviolet (UV) beam, used to expose the image sensitive material layer (e.g., photoresist) which has been coated on a wafer, is blocked by the opaque region and transmits through the transparent regions. In one example, a binary mask includes a transparent substrate (e.g., fused quartz) and an opaque material (e.g., chromium) coated in the opaque regions of the mask. In another example, the mask is formed using a phase shift technology. In the phase shift mask (PSM), various features in the pattern formed on the mask are configured to have proper phase difference to enhance the resolution and imaging quality. In various examples, the phase shift mask can be attenuated PSM or alternating PSM. The mask(s) generated by the mask fabrication 734 is used in a variety of processes. For example, such a mask(s) is used in an ion implantation process to form various doped regions in the semiconductor wafer, in an etching process to form various etching regions in the semiconductor wafer, and/or in other suitable processes.

The IC fab 740 is an IC fabrication entity that includes one or more manufacturing facilities for the fabrication of a variety of different IC products. In some embodiments, the IC fab 740 is a semiconductor foundry. For example, there may be a first manufacturing facility for the front end fabrication of a plurality of IC products (e.g., source/drain structures, gate structures), while a second manufacturing facility may provide the middle end fabrication for the interconnection of the IC products (e.g., MDs, VDs, VGs) and a third manufacturing facility may provide the back end fabrication for the interconnection and packaging of the IC products (e.g., M0 tracks, M1 tracks, BM0 tracks, BM1 tracks), and a fourth manufacturing facility may provide other services for the foundry entity.

The IC fab 740 uses the mask (or masks) fabricated by the mask house 730 to fabricate the IC device 760. Thus, the IC fab 740 at least indirectly uses the IC design layout 722 to fabricate the IC device 760. In some embodiments, a semiconductor wafer is fabricated by the IC fab 740 using the mask (or masks) to form the IC device 760. The semiconductor wafer 742 includes a silicon substrate or other proper substrate having material layers formed thereon. Semiconductor wafer further includes one or more of various doped regions, dielectric features, multilevel interconnects, and the like (formed at subsequent manufacturing steps).

Also disclosed is a device. The device includes a charge pump and a first switch. The charge pump is configured to output an output voltage signal according to a first node. The charge pump includes a first diode and a clock buffer. The first diode is configured to receive a first voltage signal and is coupled to the first node. The clock buffer is configured to adjust the first node according to a second node. The first switch is configured to adjust the second node according to the first voltage signal.

Also disclosed is a device. The device includes a charge pump, a regulator and a controller. The charge pump is configured to generate a first voltage signal and a second voltage signal to generate an output voltage signal. The regulator is configured to adjust the second voltage signal to a first voltage level according to the first voltage signal and a third voltage signal. The controller is configured to control the third voltage signal according to the first voltage signal and a fourth voltage signal. The output voltage signal has a second voltage level. The fourth voltage signal has a third voltage level. The third voltage level is approximately equal to one-Nth of the second voltage level, for N being a positive integer.

Also disclosed is a method. The method includes: inputting a first voltage signal and a second voltage signal to a controller; outputting a third voltage signal from the controller according to the first voltage signal and the second voltage signal; and generating a fourth voltage signal according to the third voltage signal and a supply voltage signal. A first voltage level of the first voltage signal is approximately equal to one-Nth of a second voltage level of the fourth voltage signal, for N being a positive integer. A third voltage level of the second voltage signal is approximately equal to one-Nth of a fourth voltage level of the supply voltage signal.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. A device, comprising:
a charge pump configured to output an output voltage signal according to a first node, the charge pump comprising:
a first diode configured to receive a first voltage signal and coupled to the first node; and
a clock buffer configured to adjust the first node according to a second node; and
a first switch configured to adjust the second node according to the first voltage signal.

2. The device of claim 1, further comprising:
a controller configured to provide a second voltage signal to a third node; and
a first amplifier configured to receive the second voltage signal from the third node,
wherein an output terminal of the first amplifier is coupled to a control terminal of the first switch.

3. The device of claim 2, wherein
the output voltage signal has a first voltage level,
the first voltage signal has a second voltage level,
the second voltage signal has a third voltage level, and
the first voltage level is approximately equal to a sum of the second voltage level and the third voltage level.

4. The device of claim 3, wherein the controller further comprises:
a first converter coupled to the third node, the first converter comprising:
a plurality of switches comprising a second switch and a third switch,
wherein each of first terminals of the plurality of switches is coupled to the third node,
each of second terminals of the plurality of switches is configured to receive the first voltage signal, and
each of control terminals of the plurality of switches is coupled to a fourth node.

5. The device of claim 4, wherein the controller further comprises:
a second converter coupled to the fourth node, the second converter comprising:
a fourth switch; and
a second amplifier configured to receive a third voltage signal,
wherein each of an output terminal of the second amplifier and a control terminal of the fourth switch is coupled to the fourth node,
the third voltage signal has a fourth voltage level, and
the fourth voltage level is approximately equal to one-Nth of the first voltage level, for N being a positive integer.

6. The device of claim 5, wherein
the first converter further comprises a first resistor,
a first terminal of the first resistor is coupled to the third node,
the second converter further comprises a second resistor,
a first terminal of the second resistor is coupled to a first terminal of the fourth switch, and
a second terminal of the fourth switch is configured to receive the first voltage signal.

7. The device of claim 6, wherein
the first resistor has a first resistance,
the second resistor has a second resistance, and
the first resistance is approximately X times the second resistance, for X being a positive integer.

8. The device of claim 7, wherein
a number of the plurality of switches is M, for M being a positive integer, and
M multiplied by X divided by N equals 1.

9. The device of claim 8, wherein the second converter further comprises:
a fifth switch; and
a third amplifier configured to receive a fourth voltage signal, wherein an output terminal of the third amplifier is coupled to a control terminal of the fifth switch,
a terminal of the fifth switch is coupled to a second terminal of the second resistor, and
a voltage level of the fourth voltage signal is approximately equal to one-Nth of the second voltage level.

10. A device, comprising:
a charge pump configured to generate a first voltage signal and a second voltage signal to generate an output voltage signal;
a regulator configured to adjust the second voltage signal to a first voltage level according to the first voltage signal and a third voltage signal; and
a controller configured to control the third voltage signal according to the first voltage signal and a fourth voltage signal,
wherein the output voltage signal has a second voltage level,
the fourth voltage signal has a third voltage level, and
the third voltage level is approximately equal to one-Nth of the second voltage level, for N being a positive integer.

11. The device of claim 10, wherein the controller further comprises:
a plurality of switches comprising a first switch and a second switch,
wherein each of first terminals of the plurality of switches is coupled to a first node,
each of second terminals of the plurality of switches is configured to receive the first voltage signal, and
the regulator is configured to receive the third voltage signal from the first node.

12. The device of claim 11, wherein the controller further comprises:
a third switch configured to adjust a voltage level of a second node to the third voltage level according to the first voltage signal; and
a first amplifier configured to receive the fourth voltage signal,
wherein each of an output terminal of the first amplifier and each of control terminals of the third switch and the plurality of switches is coupled to each other.

13. The device of claim 12, wherein the controller further comprises:
a first resistor; and
a second resistor coupled to the first node,
wherein a first terminal of the first resistor is coupled to the second node.

14. The device of claim 13, wherein the controller further comprises:
a fourth switch configured to adjust a voltage level of a third node to a fourth voltage level according to the first voltage signal,
wherein a second terminal of the first resistor is coupled to the third node,
the first voltage signal has a fifth voltage level, and
the fourth voltage level is approximately equal to one-Nth of the fifth voltage level.

15. The device of claim 14, wherein
a resistance of the second resistor is approximately X times a resistance of the first resistor, for X being a positive integer,
a number of the plurality of switches is M, for M being a positive integer, and
M multiplied by X divided by N equals 1.

16. The device of claim 14, wherein
each of the first switch, the second switch and the third switch corresponds to a first conductive type, and
the fourth switch corresponds to a second conductive type different from the first conductive type.

17. A method, comprising:
inputting a first voltage signal and a second voltage signal to a controller;
outputting a third voltage signal from the controller according to the first voltage signal and the second voltage signal; and
generating a fourth voltage signal according to the third voltage signal and a supply voltage signal,
wherein a first voltage level of the first voltage signal is approximately equal to one-Nth of a second voltage level of the fourth voltage signal, for N being a positive integer, and
a third voltage level of the second voltage signal is approximately equal to one-Nth of a fourth voltage level of the supply voltage signal.

18. The method of claim 17, further comprising:
adjusting a first node of the controller to a fifth voltage level by a plurality of switches according to each of the supply voltage signal, the first voltage signal, a first resistor and a second resistor,
wherein the third voltage signal has the fifth voltage level,
a number of the plurality of switches is M, for M being a positive integer,
each of control terminals of the plurality of the switches is coupled to each other,
a resistance of the second resistor is approximately X times a resistance of the first resistor, for X being a positive integer, and
M multiplied by X divided by N equals 1.

19. The method of claim 17, further comprising:
adjusting a first node of the controller to the first voltage level by a first switch and a first amplifier according to the supply voltage signal and the first voltage signal,
wherein a control terminal of the first switch is coupled to an output terminal the first amplifier.

20. The method of claim 19, further comprising:
adjusting a second node of the controller to the third voltage level by a second switch and a second amplifier according to the supply voltage signal,
wherein a control terminal of the second switch is coupled to an output terminal the second amplifier.
